(19) United States
(12) Patent Application Publication
(10) Pub. No.: US 2021/0157084 A1
(43) Pub. Date: May 27, 2021

(54) CONFIGURABLE MONOCULAR DISPLAY MOUNT

(71) Applicant: Six15 Technologies, Henrietta, NY (US)

(72) Inventors: Theodore K. Ricks, Pittsford, NY (US); Stanley W. Stephenson, Spencerport, NY (US)

(21) Appl. No.: 16/695,446

(22) Filed: Nov. 26, 2019

(51) Int. Cl. G02B 7/00; G02C 9/00; G02C 11/00; A42B 3/04

(52) U.S. Cl. CPC G02B 7/002; A42B 3/042; G02C 11/10; G02C 9/00

(57) ABSTRACT

An apparatus has a monocular optic for viewing from either a right eye or a left eye of a viewer. A bilateral connecting arm extends between the monocular optic and a coupling on a head-worn article worn by the viewer. The bilateral connecting arm is configured for repeatably decoupling from, and recoupling to, the head-worn article for switching between a first orientation that disposes the monocular optic in a left eye viewing position and a second orientation that disposes the monocular optic in a right eye viewing position.

### FIELD OF THE INVENTION

The present disclosure relates generally to the field of head-mounted optics, and in particular to mounting arrangements for display or other optic components. More specifically, inventive content relates to apparatus and methods for mounting a monocular display or other optic to a helmet for switchable left-eye or right-eye viewing.

### BACKGROUND

Displays and other optic and imaging apparatus can be mounted to a helmet using a variety of attachment techniques. Once attached, the display position must be adjusted for a user's facial geometry. For example, proper visibility of the display can require apparatus adjustment to center each display to the line of sight along the center of a user's eyes. Displays attachable to a helmet can display information content or images. Depending on design requirements, a single monocular display can present an image to one eye or two displays can be positioned, one in front of each eye, to form a binocular display. In some cases, informational data is projected over a scene that is viewed directly by a user to create an “augmented” scene combining the directly viewed image with overlaid information pertinent to objects in the viewed scene, or related to instructions or nearby objects, for example.

A display or other optic that is provided from a helmet or other headgear or head-worn article often requires adjustment so that the display is suitably positioned in front of the eye for viewing. The best position for an individual viewer may be either right-eye viewing position or left-eye viewing position.

Typically, a display holding mechanism is attached as an integral part of the helmet and holds the display. The holding mechanism can include adjustments to position the display vertically, to position laterally, and to control display extension. Additionally, a rotational component can be part of the holding mechanism, enabling display correction relative to the eye with respect to roll, pitch. and yaw. There can be a number of such mechanisms used for head-mounted display.

With some display apparatus, switching between left- and right-eye display can be performed by pivoting components from one position to the other, without any disassembly. One type of system uses vertical and extension adjustments for an optical attachment and further incorporates two rotational joints to position a monocular display. The mechanism permits positioning of the monocular display in front of either eye without disassembling the mechanism. The two joints can be released to permit the display to swivel between eyes and the joints are tightened after positioning to secure the display in each position in front of an eye. This type of mechanism typically requires numerous parts; the function of providing a switchable arrangement of this type can add bulk and can require a large amount of space.

Removal of components and movement to another orientation or location is another option. For example, mechanisms are described having vertical adjustment, extension adjustment with independent lead screws to adjust each of two displays laterally. Various embodiments teach the use of a metal block called a “shoe” to provide attachment to a mating nest that locks the display or other optic to the mechanism. A display assembly can be temporarily removed and released from each lateral adjustment in order to switch a single display between view positions for one eye and another. However, the use of two separate lateral adjustment mechanisms typically creates a large, complex assembly with multiple parts and having significant weight, a disadvantage for the helmet wearer. Release mechanisms add further weight and complexity.

Thus, although existing solutions have provided some solutions for display mounting on a helmet or other head-worn article, there is room for improvement. For example, there is need for a simple mechanism which permits switching a monocular display between the right and left eye positions, while retaining adjustability when in either eye-position. The mechanism should be simple, allowing straightforward change between positions and requiring a minimum of parts. For example, it would be useful to have a given set of parts that configure the display without the need for additional parts in adapting the display mount.

### SUMMARY

It is an object of the present disclosure to advance the art disposing a display or other viewing optic within the field of view of a viewer, such as a helmet wearer.

Another object of the present disclosure is to provide display optic attachment to the helmet with reduced parts count, weight, size, and complexity over conventional designs.

According to one aspect of the disclosure, there is provided an apparatus comprising:
a) a monocular optic for viewing from either a right eye or a left eye of a viewer; and
b) a bilateral connecting arm that extends between the monocular optic and a coupling on a head-worn article worn by the viewer, wherein the bilateral connecting arm is configured for repeatably decoupling from, and recoupling to, the head-worn article for switching between:
   (i) a first orientation that disposes the monocular optic in a left eye viewing position; and
   (ii) a second orientation that disposes the monocular optic in a right eye viewing position.

These objects are given only by way of illustrative example, and such objects may be exemplary of one or more embodiments of the disclosure. Other desirable objectives and advantages inherently achieved may occur or become apparent to those skilled in the art. The invention is defined by the appended claims.

### BRIEF DESCRIPTION OF THE DRAWINGS

The foregoing and other objects, features, and advantages of the disclosure will be apparent from the following more particular description of various embodiments, as illustrated in the accompanying drawings.

The elements of the drawings are not necessarily to scale relative to each other.

FIG. 1 is a front view of a display mounted to a helmet in accordance with an embodiment of the present disclosure, with the display mount configured for right eye viewing.

FIG. 2A is a perspective view of the display optical apparatus.

FIG. 2B is a perspective view of the display optical apparatus according to an alternate embodiment.

FIG. 3 is a perspective exploded view of the optical apparatus disposed in position for right-eye viewing.

FIG. 4 is a perspective exploded view of the optical apparatus disposed in position for left-eye viewing.

FIG. 5 is a perspective view of an optical apparatus of the present disclosure mounted on a helmet in the left eye viewing position.

FIG. 6 is a front view showing the interface between an optic and a helmet, according to an embodiment of the present disclosure.

### DETAILED DESCRIPTION

The following is a detailed description of preferred embodiments, reference being made to the drawings in which the same reference numerals identify the same elements of structure in each of the several figures.

Figures provided herein are given in order to illustrate principles of operation and component relationships according to the present disclosure and are not drawn with intent to show actual size or scale. Some exaggeration may be necessary in order to emphasize basic structural relationships or principles of operation. Some conventional components that would be needed for implementation of the described embodiments, such as support components used for providing power, for packaging, and for mounting, for example, are not shown in the drawings in order to simplify description. In the drawings and text that follow, like components are designated with like reference numerals, and similar descriptions concerning components and arrangement, or interaction of components already described may be omitted.

Where they are used, the terms “first”, “second”, and so on, do not necessarily denote any ordinal or priority relation, but may be used for more clearly distinguishing one element or time interval from another. The term “plurality” means at least two.

In the context of the present disclosure, positional terms such as “top” and “bottom”, “upward” and “downward”, and similar expressions are used descriptively, to differentiate different surfaces, sides, or views of an assembly or structure and do not describe any necessary orientation of the assembly in an optical or electromechanical apparatus.

In the context of the present disclosure, the term “coupled” is intended to indicate a mechanical association, connection, relation, or linking between two or more components, such that the disposition of one component affects the spatial disposition of a component to which it is coupled. For mechanical coupling, two components need not be in direct contact, but can be linked through one or more intermediary components.

In the context of the present disclosure, the terms “user”, “wearer”, and “viewer” may be considered equivalent when referring to the person wearing a helmet configured with the display apparatus described herein.

As used herein, the term “energizable” relates to a device or set of components that perform an indicated function upon receiving power and, optionally, upon receiving an enabling signal.

In the context of the present disclosure, the term “head-worn article” can include types of headgear, including helmets, hard-hats, hats and caps, and protective hoods, as well as eyeglasses, goggles, and various types of eyewear that seat externally, with support along the sides or top of the viewer's head.

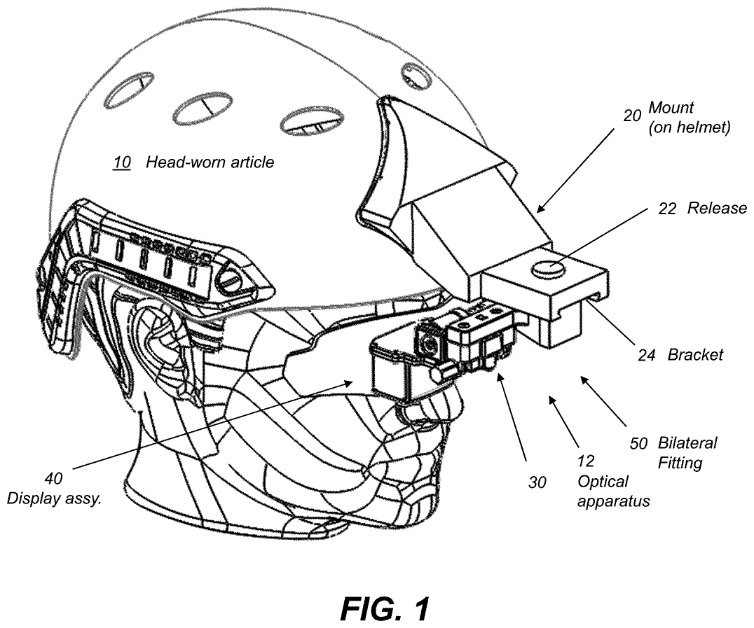

FIG. 1 is a front view of an optical apparatus 12 that is removably coupled to a fixed display mount 20. Display mount 20 is a type of coupling that is integrally attached as part of a head-worn article shown as helmet 10, according to an embodiment of the present disclosure. The coupling that is provided on helmet 10 or other type of head-worn article can be fastened to the head-worn article, adhesively attached to the article, or formed as an integral part of the the head-worn article, such as molded or otherwise formed as part of a surface. The coupling that is provided on the head-worn article need not necessarily be located centrally (such as corresponding horizontally to the space between the viewer's eyes), but may be offset to one side or the other.

The FIG. 1 configuration shows optical apparatus 12 configured in position for right-eye viewing (viewing through the right eye of the viewer.) Helmet 10 or other head-worn article can be made of rigid or flexible parts that provide a suitable mounting surface for display mount 20 or other optic. Helmet 10 or, more generally, the head-worn article, may or may not be protective and can, in a very general aspect, be a head covering having sufficient structural strength for supporting mounted displays or other optical components in accordance with the present disclosure. For example, helmet 10 can be designed for military, industrial, or recreational use.

Display mount 20 is attached to helmet 10 and serves as a coupling to support displays and other optical components such as imaging cameras or optics such as lenses, lens systems, optical filters, polarizers, and the like. In embodiments shown herein, display mount 20 extends outward from the headgear for attachment of an optic. Display mount 20 can have a series of brackets or other retainers that, in turn, can have embedded adjustments that allow adjustable optical apparatus 12 to translate a display or other optic horizontally or vertically, relative to the wearer, or extensively, that is, outward, such as along the viewer's line of sight. Adjustments can also provide various ways to rotate an attached optic, such as to align a displayed image or optic to one or both eyes of the viewer.

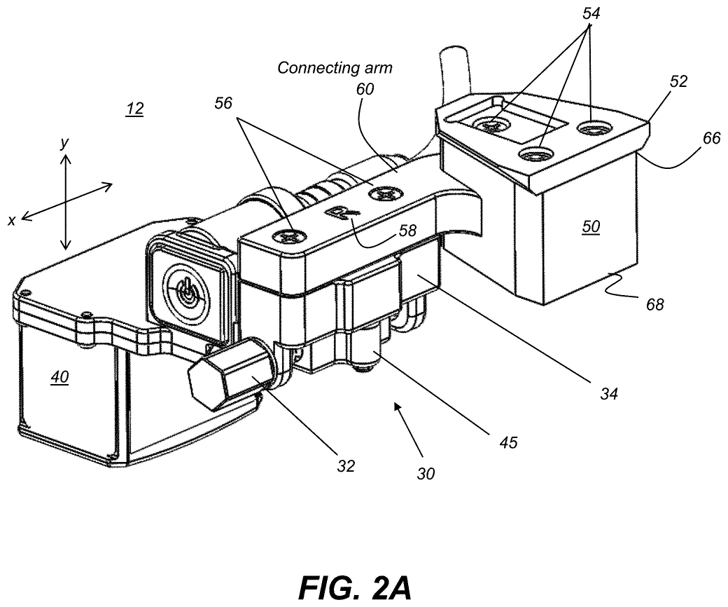

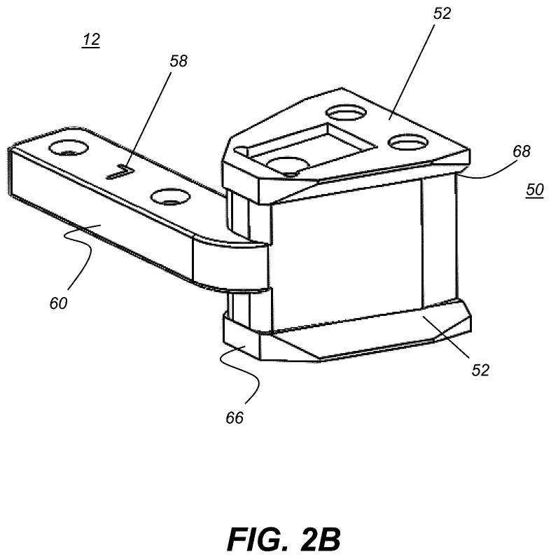

Optical apparatus 12 of the present disclosure is shown coupled to display mount 20 in FIG. 1 and uncoupled and separated from display mount 20 in FIG. 2A. In embodiments shown herein, optical apparatus 12 has a display assembly 40 as a type of monocular optic that provides generated display content. In alternate embodiments, optical apparatus 12 can include various types of optics or optical devices, including but not limited to cameras, optical filters, magnifiers, measurement optics, optical sensors, polarizers, and other monocular light-generating, light conditioning. or light-detecting apparatus.

As shown in FIG. 1, optical apparatus 12 is fitted into an attachment socket or bracket 24 that is part of attached display assembly 40. In the particular example of FIG. 1, a standard, railed dovetail or “shoe” fitting is shown for attachment bracket 24. An optional attachment release 22 can be a latch or button that is pressed, moved, or otherwise actuated to release optical apparatus 12 from its attachment. Attachment release 22 is a mechanism that can be configured to eject a bilateral fitting 50 of optical apparatus 12 or otherwise actuate a spring or other device in order to loosen or free a mechanical connection. Release 22 can alternately be a mechanical fastener that is removable or loosens to release optical apparatus 12 in order to remove or reposition optical apparatus 12.

Display assembly 40 can consist of a display and a set of optics enclosed within a housing, with the display energizable to present image monochrome or color image content within the field of vision of the viewer. Display assembly 40 can be configured for virtual reality (VR) imaging, in which viewer visibility is constrained to the generated image content on the display, or for augmented reality (AR) imaging, in which generated image content from the display appears to be overlaid onto one or more portions of the external scene, so that at least portions of the external scene remain visible to the viewer.

Optical apparatus 12 can further include an optional translation mechanism 30 that permits lateral movement of the generated image across the viewer field of view (FOV). The lateral adjustment allows compensation for variable inter-pupil distance (IPD) in the viewer population. Further adjustments for display position or orientation can also be made, such as providing alternate locations for an image presented within the viewer field of view. FIG. 1 shows a mounting arrangement for optical apparatus 12 wherein mounting shoe 52 (FIG. 2A) is complementary to the attachment bracket 24 of the helmet, so that bilateral fitting 50, when seated, inserted, or otherwise fitted within mounting shoe 52, slides into an attachment bracket 24 of display mount 20 in dovetail fashion.

FIG. 2A is a perspective view that shows optical apparatus 12 for display assembly 40 positioning according to an embodiment of the present disclosure. Bilateral fitting 50 can be a block or other suitable connective structure having a first surface 66 and a second surface 68 opposite the first surface. A mounting shoe 52 can fasten to either or both first surface 66 or second surface 68. With mounting shoe 52 fastened or otherwise seated against first surface 66, optical apparatus 12 provides a configuration for the optic, positioned suitably for right-eye viewing, as in the configuration shown in FIG. 2A. With mounting shoe 52 seated against second surface 68, optical apparatus 12 provides the optic in a left-eye viewing position.

According to an embodiment of the present disclosure, mounting shoe 52 can be removable for repositioning at one of two alternative positions: attached to surface 66 for the right eye or to surface 68 for the left-eye viewing position. This arrangement thus allows the end-user to configure the display device for either left- or right-eye viewing, using the same fastener hardware, for example. Referring to both FIGS. 2A and 2B, a bilateral connecting arm 60 extends toward the bilateral fitting from the monocular optic, extending outward and to the side from bilateral fitting 50, in a direction orthogonal to an axis that is normal to both surfaces 68, 66. One end of bilateral connecting arm 60 fastens to display assembly 40 or other optic, in order to suspend display assembly 40 into the line of sight position for either the right or left eye of the viewer. The opposite end of connecting arm 60 can be fitted into a slot formed in fitting 50 and retained within the slot or otherwise held against fitting 50 by one or more fasteners 54, for example. Shoe 52 can alternately be molded into fitting 50 itself.

FIG. 2B shows a perspective view of optical apparatus 12 in an alternate embodiment of the present disclosure. In the FIG. 2B arrangement, optical apparatus 12 has two shoes 52 in place, with a corresponding shoe 52 on both first and second surfaces 66, 68. One shoe 52 serves for attachment for right-eye viewing; another shoe 52 is positioned to allow rapid switching between left and right eye view configurations. As is indicated by R/L indicia 58, FIG. 2A shows the right-eye viewing configuration, using shoe 52 seated on surface 66; FIG. 2B shows a left-eye viewing configuration, using shoe 52 on surface 68. Changing from left- to right-eye viewing can be straightforward: simply depressing or otherwise actuating release 22 of display mount 20, removing and rotating optical apparatus 12 to the alternate L/R position, then reinserting the optical apparatus 12 into the display mount 20. This action is repeatable, to adapt optical apparatus 12 for the preferred eye for each viewer.

Referring back to FIG. 2A, attachment shoe 52 can be secured to bilateral fitting 50 using fasteners 54, such as a set of screws. Attachment shoe 52 permits display 40 to be connected to fixed display mount 20 on the helmet through attachment bracket 24. Bilateral connecting arm 60 that extends between the monocular optic and coupling to the head-worn article can be attached to optional translation mechanism 30 by fasteners 56.

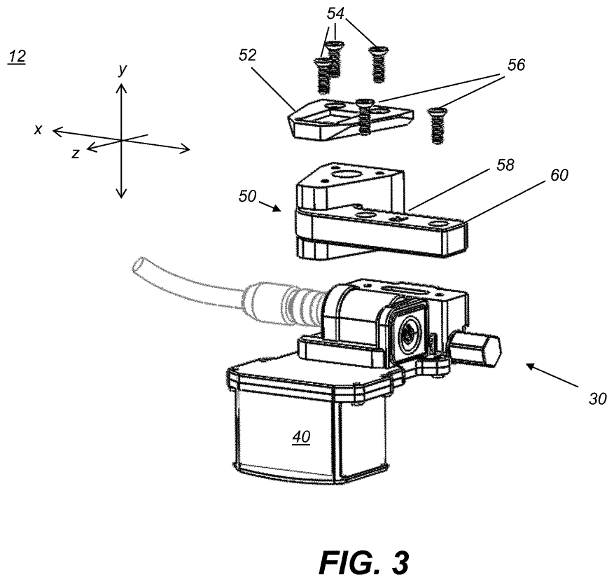

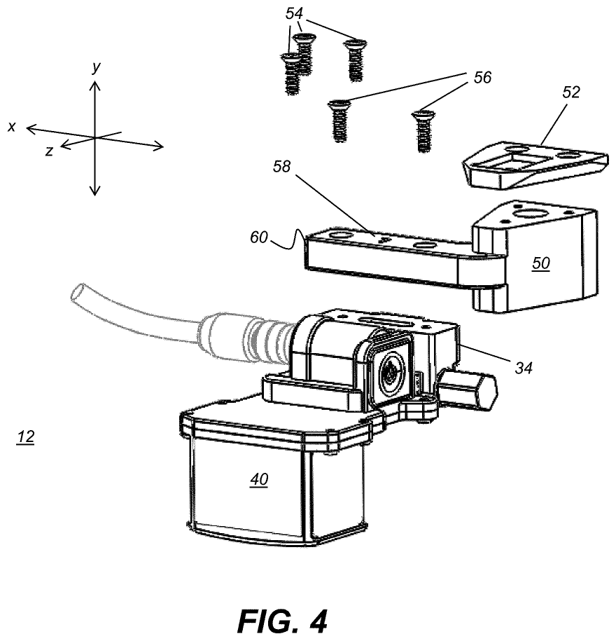

Exploded views of FIGS. 3 and 4 show, in more detail, how optical apparatus 12 can be repeatedly configured for right- or left-eye orientation where more disassembly is required. In the embodiment of optical apparatus 12 that is shown, fasteners 54, 56 are removed in order to make the transition between positions. The orientation of bilateral fitting 50 and its cooperating connecting arm 60 is changed by 180 degrees about the z-axis (axial), as shown. The change between left- and right-eye viewing orientations thus inverts surfaces of bilateral connecting arm 60 as coupled to attachment bracket 24.

Bilateral connecting arm 60 and any associated bilateral fitting 50 are designed so that de-coupling and reorientation with respect to the display or optic component is straightforward and repeatable. The arrangement of bilateral fitting 50 of bilateral connecting arm 60 configures rapid setup and reconfiguration, so that display assembly 40 can be aligned vertically and horizontally with a viewer's left and right eyes. This process is shown in FIG. 3 and FIG. 4. FIG. 3 is a perspective exploded view showing optical apparatus 12 disassembled from right-eye viewing configuration, with fasteners 54, 56 removed. It can be observed that translation mechanism 30 need not be disassembled for the left-eye/right-eye transition of display assembly 40. A common set of parts is used for both configurations, eliminating the need for loose components.

FIG. 4 is a perspective view of optical apparatus 12 disassembled from left-eye viewing configuration. Bilateral fitting 50 and connecting arm 60 have reversed orientation from that shown in FIG. 3. This arrangement advantageously permits mounting of display assembly 40 from a single fixture on helmet 10 for both left- and right-eye viewing.

It can be appreciated that any suitable type of fasteners or devices can be configured to secure or release the connection arm. Repeatable reconfiguration of the optical apparatus for use with the alternate eye can use the following general sequence:
(i) Disassembly or de-coupling, removing the bilateral connecting arm 60 from its coupling against the head-worn article;
(ii) Re-orientation, rotating or otherwise re-orienting the bilateral connecting arm 60, along with re-attaching any necessary fasteners; and
(iii) Reassembly and recoupling, restoring bilateral connecting arm 60 to a coupled position against the head-worn article.

Re-orientation inverts the bilateral connecting arm 60, such as switching a top surface to a bottom surface within a fitting or reversing arm direction from left to right with respect to the head-worn article, for example. The coupled position of connecting arm 60 may be effected by insertion into a fitting.

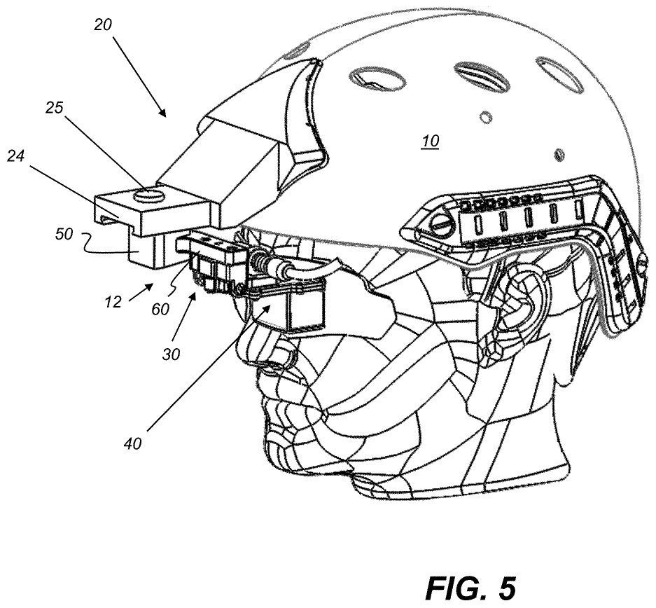

FIG. 5 is a perspective view showing optical apparatus 12 mounted on a helmet in the left-eye viewing position. By default, the setup outlined earlier with reference to FIG. 4 positions display assembly 40 in front of the viewer's left eye at equivalent inter-pupil distance and height that apply for the right eye. However, because eye position on a wearer's face can differ between the two eyes, some adjustments may still be required in order to properly position display apparatus 40 in the monocular display system shown.

An embodiment of the present disclosure requires only a single translation mechanism 30 for use with either eye. The use of a single lateral adjustment improves over mechanisms that have separate translation stages, such as one for each eye in display mount 20. The use of a single translation mechanism 30 can help to reduce weight and cost associated with a dual lateral adjustment mechanism.

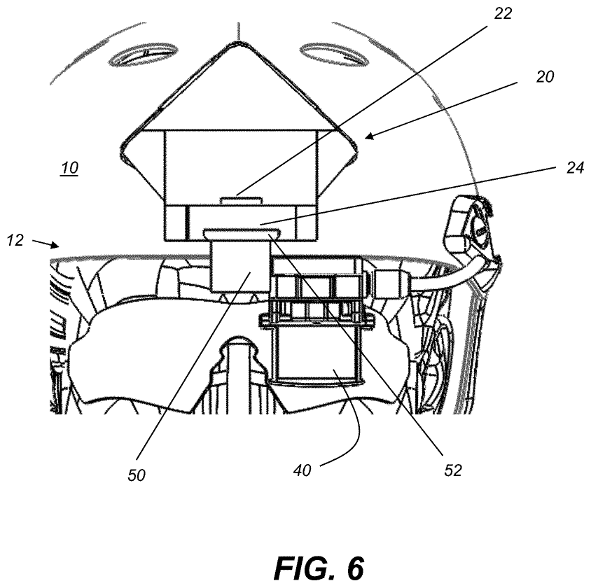

FIG. 6 is a front view of helmet 10 with display apparatus 40 in position for (left-eye) viewing, coupled to display mount 20 on helmet 10 using optical apparatus 12. As noted previously, this arrangement allows mounting for either right- or left-eye viewing using only a single fixture, display mount 20, attached to helmet 10. This also helps to maintain interpupil distance as well as vertical distance when switched between positions.

Translation mechanism 30 is shown in detail in FIG. 2A. A display assembly projection 45 has a threaded passage that engages threads formed on a thrust shaft 32. Thrust shaft 32 is secured in thrust bracket 34. Thrust bracket 34 is attached to bilateral fitting 50 which attaches to helmet 10 as described previously. Turning thrust shaft 32 causes thrust bracket 34 to translate display assembly 40 along the x coordinate axis, that is, laterally with respect to a user's eye in either the left eye or right eye configuration. Translation mechanism 30 can be in an area of the system that minimizes size, weight and complexity.

Bilateral fitting 50 of connecting arm 60 can have a specific orientation for providing visibility to each eye of the viewer. Translation mechanism 30, configured to shift the position of the monocular optic along a line between the viewer's eyes, can be incorporated into display mount 20. In that configuration, translation mechanism 30 operates from a central attachment point on helmet 10 to permit bilateral connecting arm 60 to position display assembly 40 over either eye.

Indicia 58 can be engraved, printed, stamped, or labeled on bilateral fitting 50 to assist the viewer in reconfiguring the mechanism. An indicial text or letter (for example, “R” or “L” as shown in FIGS. 2A and 2B) can serve to indicate when bilateral fitting 50 and connecting arm 60 are in position for one eye or the other. Alternatively, other types of symbols or images can be used to indicate to indicate when connecting arm 60 is in a given position.

Advantageously, an embodiment of the present disclosure allows the image on a display to have the same orientation with apparatus 12 in either right- or left-eye viewing position. Thus, there is no need to sense display position in order to adjust the sequence of data delivery to the display.

The disclosure has been described in detail with particular reference to a presently preferred embodiment, but it will be understood that variations and modifications can be effected within the spirit and scope of the disclosure. The presently disclosed embodiments are therefore considered in all respects to be illustrative and not restrictive. The scope of the disclosure is indicated by the appended claims, and all changes that come within the meaning and range of equivalents thereof are intended to be embraced therein.

What is claimed is:

1. An apparatus comprising:
a) a monocular optic for viewing from either a right eye or a left eye of a viewer; and
b) a bilateral connecting arm that extends between the monocular optic and a coupling on a head-worn article worn by the viewer, wherein the bilateral connecting arm is configured for repeatably decoupling from, and recoupling to, the head-worn article for switching between:
(i) a first orientation that disposes the monocular optic in a left eye viewing position; and
(ii) a second orientation that disposes the monocular optic in a right eye viewing position.

2. The apparatus of claim 1 wherein switching between the first and second orientations inverts surfaces of the bilateral connecting arm within the coupling.

3. The apparatus of claim 1 wherein the coupling has a release mechanism configured for decoupling of the bilateral connecting arm.

4. The apparatus of claim 1 wherein the coupling comprises a bracket on the head-worn article.

5. The apparatus of claim 2 wherein the coupling seats a removable shoe.

6. The apparatus of claim 5 wherein the removable shoe attaches to the bilateral connecting arm using one or more adjustable fasteners.

7. The apparatus of claim 1 wherein the head-worn article is a hat or helmet.

8. The apparatus of claim 1 wherein the head-worn article is a pair of eyeglasses.

9. The apparatus of claim 1 wherein the bilateral connecting arm has one or more fasteners for coupling to the head-worn article.

10. The apparatus of claim 1 wherein the bilateral connecting arm has one or more fasteners for coupling to the monocular optic.

11. The apparatus of claim 1 wherein the bilateral connecting arm is adjustable in length for extending the monocular optic from the coupling.

12. The apparatus of claim 1 wherein the monocular optic is a display.

13. The apparatus of claim 1 wherein the monocular optic is taken from the group consisting of a camera, an optical filter, a magnifier, a polarizer, and an optical sensor.

14. The apparatus of claim 1 further comprising a translation mechanism that is configured to shift the position of the monocular optic along a line between the viewer's eyes.

15. An apparatus comprising:
a) a monocular display for viewing from either a right eye or a left eye of a viewer; and
b) a bilateral connecting arm that extends between the monocular display and a coupling mounted on a head-worn article worn by the viewer, wherein the bilateral connecting arm is configured for repeatably decoupling from, and recoupling to, the head-worn article for switching between:
(i) a first orientation that disposes the monocular display in a left eye viewing position; and
(ii) a second orientation that disposes the monocular display in a right eye viewing position,
wherein the bilateral connecting arm comprises one or more removable fasteners and a fitting that seats in the coupling.

16. A method for switching a monocular optic between first and second viewing positions, the method comprising:
a) coupling the monocular optic to a bilateral connecting arm;
b) attaching the bilateral connecting arm to a coupling on a head-worn article worn by a viewer in a first orientation, with the monocular optic in the first viewing position;
c) detaching the bilateral connecting arm from the coupling;
d) inverting the bilateral connecting arm orientation with respect to the coupling;
and
e) re-attaching the bilateral connecting arm to the coupling with the monocular optic in the second viewing position.

17. The method of claim 16 further comprising removing and repositioning one or more fasteners of a fitting for re-attaching the connecting arm in the second viewing position.

18. The method of claim 16 wherein inverting the bilateral connecting arm comprises rotating the bilateral connecting arm within a fitting.

19. The method of claim 16 wherein attaching the bilateral connecting arm to a coupling comprises inserting the bilateral connecting arm within a fitting.
